(19) United States
(12) Patent Application Publication
(10) Pub. No.: US 2016/0116379 A1
(43) Pub. Date: Apr. 28, 2016

(54) APPARATUSES FOR STERILELY DELIVERING FLUID

(71) Applicant: Ibis Biosciences, Inc., Carlsbad, CA (US)

(72) Inventors: James C. Hannis, Carlsbad, CA (US); Sherilynn Manalili Wheeler, Carlsbad, CA (US); Thomas N. Chiesl, Carlsbad, CA (US); Jared J. Drader, Carlsbad, CA (US); Steven A. Hofstadler, Carlsbad, CA (US); Ronald K. Bergold, Carlsbad, CA (US); Paul J. Gleason, Carlsbad, CA (US); Zachary T. Hannis, Carlsbad, CA (US)

(21) Appl. No.: 14/920,652

(22) Filed: Oct. 22, 2015

Related U.S. Application Data
(60) Provisional application No. 62/067,282, filed on Oct. 22, 2014.

(51) Int. Cl. G01N 1/02; B01L 3/00

(52) U.S. Cl. CPC G01N 1/02; B01L 3/52; G01N 2001/028; B01L 2200/141; B01L 2300/0672; B01L 2300/069; B01L 2300/0832; B01L 2300/0809

(57) ABSTRACT

Provided herein are apparatuses, systems, kits and methods for sterilely delivering fluid to an elongated swab. In particular, provided herein are apparatuses configured to sterilely deliver a desired fluid to a swab contained within a swab housing.

### CROSS-REFERENCE TO RELATED APPLICATIONS

The present Application claims priority to U.S. Provisional Application Ser. No. 62/067,282 filed Oct. 22, 2014, the entirety of which is incorporated by reference herein.

### FIELD OF THE INVENTION

Provided herein are apparatuses, systems, kits and methods for sterilely delivering fluid to an elongated swab. In particular, provided herein are apparatuses configured to sterilely deliver a desired fluid to a swab contained within a swab housing.

### BACKGROUND OF THE INVENTION

Improved systems and apparatuses for sterilely delivering a fluid to an elongated swab contained within a swab housing (e.g., a SecurSwab (Bode Technology) swab housing) are needed.

### SUMMARY OF THE INVENTION

The provided apparatuses, systems, kits, and methods represent significant improvements involving the sterile use of swabs requiring the sterile application of a fluid onto the swab prior to its use. For example, unlike currently available products (e.g., a SecurSwab (Bode Technology) swab housing), the provided apparatuses, systems, kits, and methods permit a user to sterilely apply a desired fluid to a swab contained within a swab housing without having to remove the swab thereby compromising its sterility.

Accordingly, provided herein are apparatuses, systems, kits and methods for sterilely delivering fluid to an elongated swab. In particular, provided herein is an apparatus configured to sterilely deliver a desired fluid to a swab contained within a swab housing.

In certain embodiments, apparatuses for delivering fluid to an elongated swab contained within an elongated swab housing are provided. In some embodiments, the apparatus comprises a hollow main body having therein a chamber containing a fluid, a hollow applicator body positioned beneath the hollow main body, the hollow applicator body having therein a puncturing element, and an open channel positioned beneath the hollow applicator body, wherein the open channel is configured to connect with an elongated swab housing containing an elongated swab. In some embodiments, the shape of the apparatus is cylindrical. In some embodiments, puncturing of the chamber results in flow of the fluid through the interior of the hollow main body, through the hollow applicator body, and through the open channel and out the open channel. In some embodiments, the chamber is sealed such that the fluid within the chamber cannot evaporate over a period of time.

In some embodiments, the hollow main body is adjustable between a stand-by position and an activated position, wherein the chamber is intact in the stand-by position, wherein the chamber is punctured in the activated position. In some embodiments, puncturing of the chamber results in flow of the fluid through the interior of the hollow main body, through the hollow applicator body, and through the open channel and out the open channel.

In some embodiments, the open channel has an open channel distal end and an open channel proximal end, wherein the open channel proximal end is connected with the apparatus, wherein the open channel distal end is connected with the swab housing.

In some embodiments, the apparatus further comprises an elongated swab housing having a closed end and an open end, wherein the closed end is connected with the open channel. In some embodiments, the elongated swab housing contains an elongated swab. In some embodiments, the elongated swab has an end having a sample collecting and/or applicating portion, wherein the swab is positioned within the elongated swab housing such that the sample collecting and/or applicating portion is positioned at the open swab housing distal end.

In some embodiments, application of a distal force onto the hollow main body results in adjustment of the apparatus from the stand-by position to the activated position. In some embodiments, the “distal force” is applied either manually (e.g., by a user) or automatically (e.g., via automated machinery).

In some embodiments, the apparatus, the elongated swab housing and the elongated swab are sterile. In some embodiments, the sterility is maintained upon release of the fluid through the apparatus, into the elongated swab housing, and onto the elongated swab.

In certain embodiments, systems comprising an apparatus, an elongated swab, and an elongated swab housing are provided. In some embodiments, the apparatus comprises a hollow main body having therein a chamber containing a fluid, a hollow applicator body positioned beneath the hollow main body, the hollow applicator body having therein a puncturing element, and an open channel positioned beneath the hollow applicator body. In some embodiments, the apparatus is cylindrical in shape. In some embodiments, the chamber is sealed such that the fluid within the chamber cannot evaporate over a period of time.

In some embodiments, the hollow main body is adjustable between a stand-by position and an activated position, wherein the chamber is intact in the stand-by position, wherein the chamber is punctured in the activated position. In some embodiments, puncturing of the chamber results in flow of the fluid through the interior of the hollow main body, through the hollow applicator body, through the open channel and out the open channel.

In some embodiments, the elongated swab housing has a closed swab housing proximal end and an open swab housing distal end. In some embodiments, the elongated swab is contained within the swab housing.

In some embodiments, the open channel has an open channel distal end and an open channel proximal end, wherein the open channel proximal end is connected with the apparatus, wherein the open channel distal end is connected with the swab housing.

In some embodiments, the elongated swab has an end having a sample collecting and/or applicating portion, wherein the swab is positioned within the elongated swab housing such that the sample collecting and/or applicating portion is positioned at the open swab housing distal end.

In some embodiments, application of a distal force onto the hollow main body results in adjustment of the apparatus from the stand-by position to the activated position.

In some embodiments, the apparatus, the elongated swab housing and the elongated swab are sterile. In some embodiments, the sterility is maintained upon release of the fluid through the apparatus, into the elongated swab housing, and onto the elongated swab.

In certain embodiments, kits comprising an apparatus, an elongated swab, and an elongated swab housing are provided. In some embodiments, the apparatus comprises a hollow main body having therein a chamber containing a fluid, a hollow applicator body positioned beneath the hollow main body, the hollow applicator body having therein a puncturing element, and an open channel positioned beneath the hollow applicator body. In some embodiments, the apparatus is cylindrical in shape. In some embodiments, the chamber is sealed such that the fluid within the chamber cannot evaporate over a period of time.

In some embodiments, the hollow main body is adjustable between a stand-by position and an activated position, wherein the chamber is intact in the stand-by position, wherein the chamber is punctured in the activated position. In some embodiments, puncturing of the chamber results in flow of the fluid through the interior of the hollow main body, through the hollow applicator body, through the open channel and out the open channel.

In some embodiments, the elongated swab housing has a closed swab housing proximal end and an open swab housing distal end. In some embodiments, the elongated swab is contained within the swab housing.

In some embodiments, the open channel has an open channel distal end and an open channel proximal end, wherein the open channel proximal end is connected with the apparatus, wherein the open channel distal end is connected with the swab housing.

In some embodiments, the elongated swab has an end having a sample collecting and/or applicating portion, wherein the swab is positioned within the elongated swab housing such that the sample collecting and/or applicating portion is positioned at the open swab housing distal end.

In some embodiments, application of a distal force onto the hollow main body results in adjustment of the apparatus from the stand-by position to the activated position.

In some embodiments, the apparatus, the elongated swab housing and the elongated swab are sterile. In some embodiments, the sterility is maintained upon release of the fluid through the apparatus, into the elongated swab housing, and onto the elongated swab.

In certain embodiments, methods for delivering fluid from an apparatus to an elongated swab contained within an elongated swab housing comprising providing an apparatus, an elongated swab housing and an elongated swab are provided.

In some embodiments, the apparatus comprises a hollow main body having therein a chamber containing a fluid, a hollow applicator body positioned beneath the hollow main body, the hollow applicator body having therein a puncturing element, and an open channel positioned beneath the hollow applicator body. In some embodiments, the chamber is sealed such that the fluid within the chamber cannot evaporate over a period of time.

In some embodiments, the hollow main body is adjustable between a stand-by position and an activated position, wherein the chamber is intact in the stand-by position, wherein the chamber is punctured in the activated position. In some embodiments, puncturing of the chamber results in flow of the fluid through the interior of the hollow main body, through the hollow applicator body, through the open channel and out the open channel.

In some embodiments, the elongated swab housing has a closed swab housing proximal end and an open swab housing distal end.

In some embodiments, the elongated swab is contained within the swab housing.

In some embodiments, the method further involves securing the apparatus with the elongated swab housing through securing the open channel proximal end with the open swab housing distal end; and applying a distal force to the apparatus such that the fluid is released from the apparatus and flows onto the elongated swab.

In some embodiments, the method further involves removing the apparatus from the elongated swab housing. In some embodiments, the method further involves removing the swab from the swab housing. In some embodiments, the method further involves collecting a sample with the swab.

In some embodiments, the sample is a forensic sample. In some embodiments, the sample is a biological sample. In some embodiments, the sample is an environmental sample. In some embodiments, the sample is any type or kind of sample. In some embodiments, the sample is a mixture of any type or kind of sample (e.g., a biological/environmental sample; a biological/forensic sample; an environmental/forensic sample; a biological/environmental/forensic sample).

In certain embodiments, apparatuses for sterilely delivering fluid to a swab contained within a swab housing (e.g., a SecurSwab (Bode Technology) swab housing or any type or kind of variation of a SecurSwab (Bode Technology) swab housing) are provided. The apparatuses are not limited to particular types or kinds

In some embodiments, the apparatuses comprise a hollow main body having an open main body proximal end, a closed main body distal end, and a main body mid portion positioned inbetween the closed main body proximal end and the open main body distal end.

In some embodiments, the apparatuses comprise a chamber is positioned within the interior of the hollow main body, the chamber having a closed chamber distal end engaging the closed main body distal end, a closed chamber proximal end, wherein the closed chamber proximal end is puncturable, and a chamber mid portion positioned inbetween the closed chamber distal end and the closed chamber proximal end.

In some embodiments, the apparatuses comprise a hollow applicator body having an open applicator body distal end, an open applicator body proximal end, an applicator body mid portion positioned inbetween the open applicator body distal end and the open applicator body proximal end, and an elongated puncturing element positioned within the interior of the applicator body, the puncturing element having a puncturing element distal end, a puncturing element proximal end, and a puncturing element mid portion positioned between the puncturing element distal end and the puncturing element proximal end.

In some embodiments, the apparatuses comprise an open channel having an open channel distal end engaging the open applicator body proximal end, an open channel proximal end, and an open channel mid portion positioned inbetween the open channel distal end and the open channel proximal end.

In some embodiments, the main body is releasably secured with the applicator body such that the chamber proximal end is not in contact with the puncturing element distal end.

In some embodiments, the main body is configured such that application of a distal force to the main body results in distal movement of the main body in relation to the applicator body, wherein such distal movement of the main body results in engagement and puncturing of the closed chamber proximal end through engagement of the closed chamber proximal end and the puncturing element distal end.

In some embodiments, the chamber contains any kind of desired fluid (e.g., DNA buffer; lysis solution; etc.). In some embodiments, the fluid is within a suspension having therein, for example, magnetic beads, lysis buffer, PCR master mix, wash buffer, elution buffer, and/or de-ionized water. In some embodiments, the apparatus is configured such that a puncturing of the closed chamber proximal end results in release of the fluid from the chamber. In some embodiments, the chamber is empty.

In some embodiments, the closed chamber proximal end is flush or recessed relative to the main body proximal end.

The apparatuses are not limited to particular shapes. In some embodiments, the main body, applicator body, and open channel each have a cylindrical shape.

In certain embodiments, systems comprising an apparatus for sterilely delivering fluid to a swab contained within a swab housing, an elongated swab, and a swab housing (e.g., a SecurSwab swab (Bode Technology) housing or any type or kind of variation of a SecurSwab (Bode Technology) swab housing) are provided. In some embodiments, the apparatus is connected with the swab housing.

In certain embodiments, kits comprising an apparatus for sterilely delivering fluid to a swab contained within a swab housing, an elongated swab, and a swab housing (e.g., a SecurSwab (Bode Technology) swab housing or any type or kind of variation of a SecurSwab (Bode Technology) swab housing) are provided. In some embodiments, the apparatus is connected with the swab housing.

In certain embodiments, methods for sterilely delivering fluid from an apparatus to a swab contained within a swab housing (e.g., a SecurSwab (Bode Technology) swab housing or any type or kind of variation of a SecurSwab (Bode Technology) swab housing) are provided. In such embodiments, the apparatus is connected with the swab housing, the apparatus is manipulated such that fluid contained within its chamber is released and the released fluid flows through the apparatus and onto the swab while maintaining sterility.

The apparatus, systems, and kits described herein find use in any type of setting requiring the sterile application with a swab (e.g., a forensic setting, a food safety setting, a medical sampling setting, an environmental setting, a cosmetic setting, and/or an industrial cleaning setting) (e.g., any setting requiring the sterile use of swab having thereon any desired type of fluid). For example, in some embodiments wherein the setting is a DNA forensic setting, the provided apparatuses, systems, and/or kits are used to sterilely apply a desired fluid (e.g., sterile water) (e.g., DNA buffer (e.g., 10 mM tris-HCl)) to a swab contained within a swab housing (e.g., a SecurSwab (Bode Technology) swab housing or any type or kind of variation of a SecurSwab (Bode Technology) swab housing) for a sterile use within the forensic setting (e.g., sterilely collecting forensic evidence (e.g., DNA)).

Additional embodiments are described herein.

### DESCRIPTION OF THE DRAWINGS

FIGS. 1A and 1B shows a cut-away side view of an apparatus.

FIGS. 2A and 2B shows a side view of an apparatus having a hollow main body and chamber.

FIGS. 3A, 3B, 3C, and 3D shows a side view of an apparatus having a hollow applicator body and an open channel.

FIG. 4 shows a step-by-step method of using an apparatus with a swab contained within a swab housing.

### DEFINITIONS

As used herein, the term “proximal” refers to the portion of a structure that is closer to a user, while the term “distal” refers to the portion that is further from the user.

As used herein, the term “user” refers to any user of the described apparatuses, systems, kits, and/or methods. The “user” can be a medical professional (e.g., veterinarian, research scientist, doctor, nurse or other health care provider) or non-medical user (e.g., a forensic scientist) (e.g., human (e.g., human patient) or human caretaker of a non-human animal).

The term “sample” is used in its broadest sense. In one sense it can refer to an animal cell or tissue. In another sense, it is meant to include a specimen or culture obtained from any source, as well as biological and environmental samples. Biological samples may be obtained from plants or animals (including humans) and encompass fluids, solids, tissues, and gases. Environmental samples include environmental material such as surface matter, soil, water, and industrial samples. These examples are not to be construed as limiting the sample types applicable to the provided apparatuses, systems, kits, and/or methods.

As used herein, the term “forensic sample” as referred to herein includes, but is not limited to, any material (e.g., biological or non-biological) obtained from a forensic setting (e.g., a crime scene).

### DETAILED DESCRIPTION OF THE INVENTION

Swabs have been manufactured into many sizes and formats, but are typically of a basic design that consists of at least one swab head, a shaft for holding and manipulation, and possibly a container (e.g., a swab housing) for storage and transportation. Such swabs can be used as applicator swabs or oppositely as sampling swabs—many swabs are classified as both.

Though swab use is wide spread and varied in purpose, one of the major areas is for forensic sampling. For many types of forensic applications, a technician will prefer a sterile, self-contained swab (e.g., a swab sterilely housed within a swab housing) (e.g., a self-contained swab (e.g., SecurSwab (Bode Technology)).

One significant drawback that is a major inconvenience for a user both in the field and laboratory is that such a swab (sterilely housed within an enclosed swab housing) must be removed from the sterile swab housing to moisten the cotton swab head prior to collection of specific samples. In doing so the swab typically must be either held in one hand while the other hand applies a drop of liquid from some type of dispenser or placed on a somewhat flat surface to apply the liquid. Either way removing the swab from the sterile enclosure exposes the swab head to possible contaminates in addition to being a tedious and time consuming step, especially when a plethora of swab samples (e.g., tens to hundreds to thousands) of swab samples may be required at a particular setting (e.g., crime scene locations, terrorist initiated event locations, disaster locations).

The provided apparatuses, systems, methods and kits address and provide solutions for this significant drawback. Indeed, to overcome this disadvantage, experiments were conducted that resulted in the designing, developing and testing of systems and apparatuses for sterilely delivering a desired fluid to a swab contained within a swab housing while maintaining sterility of the swab. In particular, apparatuses configured to directly connect with an enclosed housing containing a swab, wherein the apparatus has therein a chamber containing a fluid to be delivered to the swab and a means for opening the chamber thereby releasing the fluid, are provided. Following connection with the enclosed housing containing the swab, the apparatus requires only a quick push activation step (e.g., application of a distal force which punctures the fluid containing chamber thereby releasing the fluid; described in more detail below) to thereby provide the fluid to the swab (e.g., moisten the swab head) while the swab is still within the sterile enclosure.

Accordingly, provided herein are systems and apparatuses for delivering fluid to an elongated swab in a sterile manner. In particular, provided herein are apparatuses configured to directly connect with an enclosed housing containing a swab, and configured to release and deliver fluid to the swab while maintaining sterility.

The following discussion includes descriptions of the various embodiments of the applicator apparatus in accordance with the principles of the present disclosure followed by a description of uses of the apparatus, systems, kits and methods.

In certain embodiments, apparatuses, systems, methods, and kits for delivering fluid to an elongated swab contained within an elongated swab housing are provided. Such embodiments are not limited to a particular configuration for the apparatus. In some embodiments, the apparatus comprises a hollow main body having therein a chamber containing a fluid, a hollow applicator body positioned beneath the hollow main body, the hollow applicator body having therein a puncturing element, and an open channel positioned beneath the hollow applicator body, wherein the open channel is configured to connect with an elongated swab housing containing an elongated swab housing. In some embodiments, the shape of the apparatus is cylindrical.

In some embodiments, the hollow main body is adjustable between a stand-by position and an activated position, wherein the chamber is intact in the stand-by position, wherein the chamber is punctured in the activated position. In some embodiments, puncturing of the chamber results in flow of the fluid through the interior of the hollow main body, through the hollow applicator body, and through the open channel and out the open channel.

In some embodiments, the open channel has an open channel distal end and an open channel proximal end, wherein the open channel proximal end is connected with the apparatus, wherein the open channel distal end is connected with the swab housing.

In some embodiments, the apparatus further comprises an elongated swab housing having a closed end and an open end, wherein the closed end is connected with the open channel. In some embodiments, the elongated swab housing contains an elongated swab. In some embodiments, the elongated swab has an end having a sample collecting and/or applicating portion, wherein the swab is positioned within the elongated swab housing such that the sample collecting and/or applicating portion is positioned at the open swab housing distal end.

In some embodiments, application of a distal force onto the hollow main body results in adjustment of the apparatus from the stand-by position to the activated position.

In some embodiments, the apparatus, the elongated swab housing and the elongated swab are sterile. In some embodiments, the sterility is maintained upon release of the fluid through the apparatus, into the elongated swab housing, and onto the elongated swab.

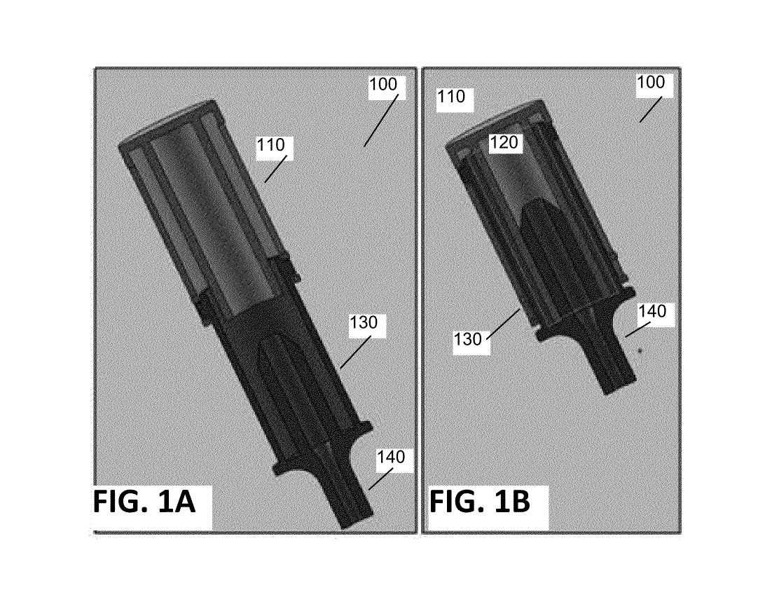

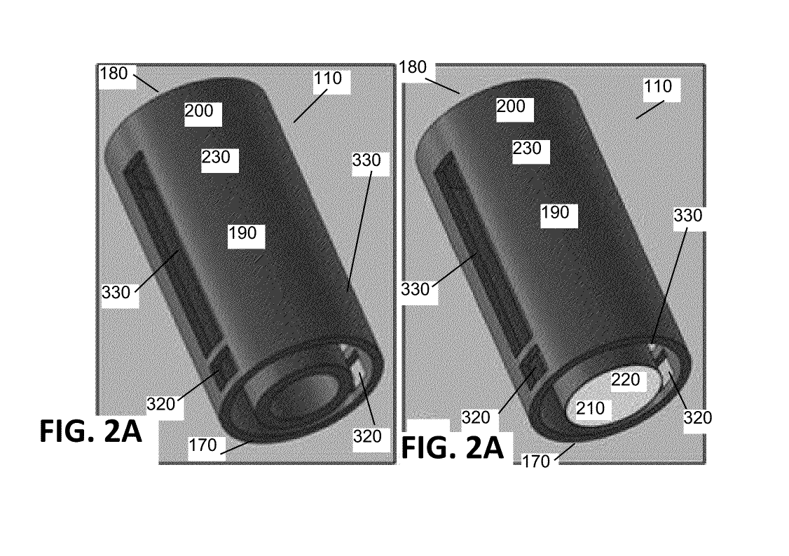

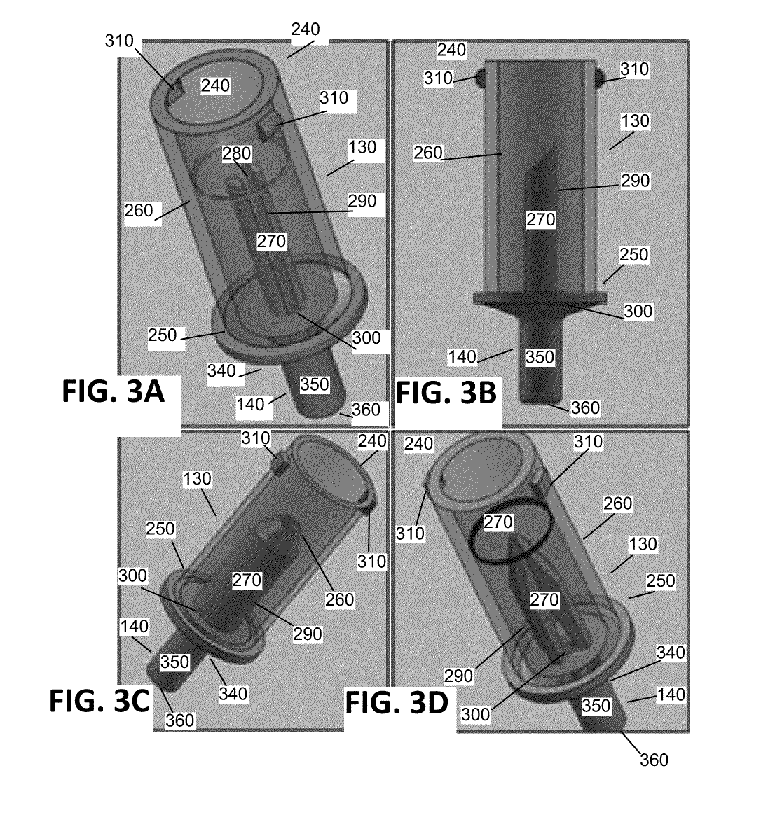

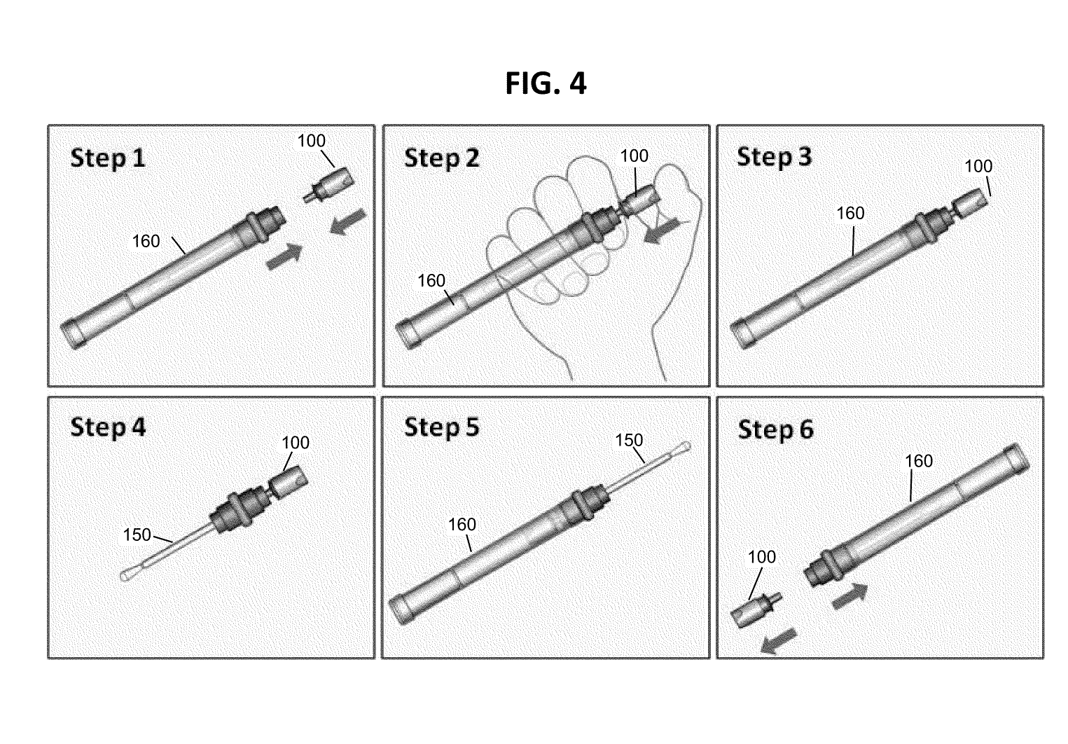

Referring to FIGS. 1-4, apparatuses for delivering fluid to an elongated swab in a sterile manner are shown. FIGS. 1A and 1B shows a cut-away side view of apparatus 100. As shown in FIGS. 1A and 1B, the apparatus 100 comprises a hollow main body 110, a chamber 120 positioned within the interior of the hollow main body 110, a hollow applicator body 130 engaged with the hollow main body 110, and an open channel 140 engaged with the hollow applicator body 130. FIG. 2 shows a side view of the hollow main body 110 and the chamber 120. FIG. 3 shows the hollow applicator body 130 and the open channel 140. FIG. 4 shows a step-by-step method of using the apparatus 100 with a swab 150 contained within a swab housing 160.

Referring to FIG. 2, the hollow main body 110 has an open main body proximal end 170, a closed main body distal end 180, and a main body mid portion 190 positioned inbetween the open main body proximal end 170 and the closed main body distal end 180. The hollow main body 110 is not limited to particular size dimensions. In some embodiments, the size of the hollow main body 110 is such that it is able to contain a chamber 120 within its interior. In some embodiments, the size of the hollow main body 110 is such that it is able to contain a chamber within its interior, wherein the chamber contains a desired amount of fluid for purposes of application with a swab contained within a swab housing (described in more detail below). In some embodiments, the size of the hollow main body 110 is such that a user (e.g., a human user) may be able to comfortably apply a distal force upon its closed main body distal end 180. In some embodiments, the size of the hollow main body 110 is such that a user (e.g., a human user) may be able to comfortably apply a distal force upon its closed main body distal end 180 for purposes of engaging the chamber within its interior with the hollow applicator body (described in more detail below). In some embodiments, the “distal force” is applied either manually (e.g., by a user) or automatically (e.g., via automated machinery). In some embodiments, the width of the hollow applicator body 180 is between 1 and 100 millimeters. In some embodiments, the length of the hollow applicator body 180 is between 1 and 100 millimeters.

Still referring to FIG. 2, the hollow main body 110 is not limited to particular shape (e.g., cylindrical, rectangular, square, conical, etc.). In some embodiments, the shape of the hollow main body 110 (as shown in FIG. 2) is cylindrical. In some embodiments, the shape of the hollow main body 110 is such that it permits housing of a chamber 120 within its interior. In some embodiments, the shape of the hollow main body 110 is such that it may be comfortably handled and/or gripped by a user (e.g., a human user). In some embodiments, the shape of the hollow main body 110 is such that it permits securing with the hollow applicator body 130 (see FIG. 1) (described in more detail below).

Still referring to FIG. 2, the hollow main body 110 is not limited to a particular material composition (e.g., plastic, metal, Kevlar, carbon, etc.). In some embodiments, the material composition of the hollow main body 110 is plastic.

Still referring to FIG. 2, the main body mid portion 190 is a region that connects the open main body proximal end 170 and the closed main body distal end 180. In some embodiments wherein the shape of the hollow main body 110 is cylindrical, the main body mid portion 190 is a cylindrical wrap-around wall. In some embodiments wherein the shape of the hollow main body 110 is not cylindrical (e.g., rectangular, conical, square), the main body mid portion 190 is one or more walls that serves to connect the open main body proximal end 170 and the closed main body distal end 180.

Still referring to FIG. 2, the open main body proximal end 170 has therein an opening of sufficient size to allow passage of a fluid (e.g., a fluid released from the chamber 120) through such opening.

Still referring to FIG. 2, a chamber 120 is positioned within the interior of the hollow main body 110. The chamber 120 has a closed chamber distal end 200 (not shown) engaging the closed main body distal end 180, a chamber mid portion 230 (not shown), and a closed chamber proximal end 210.

FIG. 2A shows the closed chamber proximal end 210 in an open state (e.g., following puncture with the hollow applicator body (described in more detail below)).

FIG. 2B shows the closed chamber proximal end 210 having a closed chamber proximal end seal 220. In some embodiments, the closed chamber proximal end seal 220 is puncturable. In some embodiments, the material composition of the closed chamber proximal end seal 220 is a puncturable foil, a puncturable plastic, etc. In some embodiments, the material composition of the closed chamber proximal end seal 220 is any material that will retain its integrity unless punctured. In some embodiments, the material composition of the closed chamber proximal end seal 220 is any material that will create a fluid tight seal over the closed chamber proximal end 210. In some embodiments, the closed chamber proximal end seal 220 is puncturable upon engagement with the hollow applicator body (described in more detail below).

Still referring to FIG. 2, the chamber 120 is not limited particular size dimensions. In some embodiments, the size of the chamber 120 is such that it is able to be secured within the interior of the hollow main body 110. In some embodiments, the size of the chamber 120 is such that it is able to be secured within the interior of the hollow main body 110 such that the closed chamber proximal end 210 is flush with the main body proximal end 170. In some embodiments, the size of the chamber 120 is such that it is able to be secured within the interior of the hollow main body 110 such that the closed chamber proximal end 210 is recessed from the main body proximal end 170. In some embodiments, the size of the chamber 120 is such that it is able to be secured within the interior of the hollow main body 110 such that the closed chamber proximal end 210 does not extend beyond the main body proximal end 170. In some embodiments, the width of the chamber 120 is between 1 and 100 millimeters. In some embodiments, the width of the chamber 120 is less than the width of the hollow main body 110. In some embodiments, the width of the chamber 120 is less than the width of the hollow main body 110 such that a gap exists between the chamber mid portion 230 and the main body mid portion 190. In some embodiments, the width of the chamber 120 is less than the width of the hollow main body 110 such that a gap exists between the chamber mid portion 230 and the main body mid portion 190, wherein the size of the gap is such that the walls of the hollow applicator body can fit within such a gap for purposes of securing the hollow main body with the hollow applicator body (described in more detail below).

Still referring to FIG. 2, the chamber 120 is not limited to particular shape (e.g., cylindrical, rectangular, square, conical, etc.). In some embodiments, the shape of the chamber 120 (as shown in FIG. 2) is cylindrical. In some embodiments, the shape of the chamber 120 is such that it matches the shape of the hollow main body 110. In some embodiments, the shape of the chamber 120 is such that it does not interfere with the securing of the hollow main body 110 with the hollow applicator body 130 (see FIG. 1) (described in more detail below).

Still referring to FIG. 2, the chamber 120 is not limited to a particular material composition (e.g., plastic, metal, Kevlar, carbon, etc.). In some embodiments, the material composition of the chamber 120 is plastic. As noted, in some embodiments, the material composition of the closed chamber proximal end seal 220 is any type of material that is able to form a fluid tight seal across the closed chamber proximal end 210 and is puncturable. In some embodiments, the material composition of the chamber 120 is such that the fluid within its interior is unable to evaporate over an extended period of time.

Still referring to FIG. 2, the chamber mid portion 230 is a region that connects the closed chamber proximal end 210 and the closed chamber distal end 200. In some embodiments wherein the shape of the chamber 120 is cylindrical, the chamber mid portion 230 is a cylindrical wrap-around wall. In some embodiments wherein the shape of the chamber 120 is not cylindrical (e.g., rectangular, conical, square), the chamber mid portion 230 is one or more walls that serves to connect the closed chamber proximal end 210 and the closed chamber distal end 200.

FIG. 2A shows the closed chamber proximal end 210 in an open state (e.g., following puncture of the closed chamber proximal end 230 with the hollow applicator body (described in more detail below). Upon puncturing of the closed chamber proximal end 230 (e.g., resulting in its opening), the closed chamber proximal end 210 has therein an opening of sufficient size to allow passage of a fluid (e.g., a fluid released from the chamber 120) out of the chamber 120.

Still referring to FIG. 2, the chamber 120 is not limited to containing a particular amount of fluid. In some embodiments, the size of the chamber 120 is such that it is able to contain a desired amount of fluid for purposes of application with a swab contained within a swab housing (described in more detail below). In some embodiments, the chamber 120 is designed to hold approximately 200 μl of fluid (e.g., 10 μl of fluid, 50 μl of fluid, 100 μl of fluid, 125 μl of fluid, 180 μl of fluid, 190 μl of fluid, 200 μl of fluid, 205 μl of fluid, 206 μl of fluid, 225 μl of fluid, 300 μl of fluid, 500 μl of fluid, 1000 μl of fluid, 100000 μl of fluid).

Still referring to FIG. 2, the chamber 120 is not limited to containing a particular type of fluid. In some embodiments, the chamber 120 contains any type of fluid that would assist the task for which the swab is being used (e.g., lysis buffer, PCR master mix, wash buffer, elution buffer, and de-ionized water). For example, in some embodiments, the type of fluid is any type of fluid that may be useful within any type of setting (e.g., a forensic setting, a food safety setting, a medical sampling setting, an environmental setting, a cosmetic setting, and/or a small parts cleaning setting). In some embodiments wherein the setting is a DNA forensic setting, the fluid is sterile water or a compatible DNA buffer (e.g., 10 mM tris-HCl). In some embodiments wherein the setting is an environmental setting, the fluid is an organic solvent. In some embodiments wherein the setting is a food safety setting, the fluid is a liquid culture based media (e.g., to promote the viability or incubation of an organism). In some embodiments wherein the setting is a cleaning/safety setting, the fluid is antibacterial and/or antimicrobial. Similarly, in some embodiments wherein the setting is health care based setting (e.g., involving a medical procedure), the fluid is antibacterial and/or antimicrobial. In some embodiments, the fluid is within a suspension having therein, for example, magnetic beads, lysis buffer, PCR master mix, wash buffer, elution buffer, and/or de-ionized water.

In some embodiments, fluids are added during manufacture and the apparatus is shipped to a user containing the fluid in the chamber. In other embodiments, the apparatus is provided to a user empty and the user adds the fluid prior to use. In some embodiments, the apparatus is intended for a single use and is disposed after use. In other embodiments, the apparatus can be refilled and used multiple times. In some embodiments, the chamber has a sufficient seal such that the fluid within its interior is not subject to evaporation over an extended period of time.

Referring to FIG. 3, the hollow applicator body 130 has an open applicator body distal end 240, an open applicator body proximal end 250, an applicator body mid portion 260 positioned inbetween the open applicator body distal end 240 and the open applicator body proximal end 250, and an elongated puncturing element 270 positioned within the interior of the hollow applicator body 130. The hollow applicator body 130 is not limited to particular size dimensions. In some embodiments, the size of the hollow applicator body 130 is such that it is able to contain an elongated puncturing element 270 within its interior. In some embodiments, the width of the hollow applicator body 130 is between 1 and 500 millimeters. In some embodiments, the length of the hollow applicator body 130 is between 1 and 500 millimeters. In some embodiments, the width of the hollow applicator body 130 is less than the width of the hollow main body (see, FIG. 1; thereby facilitating connection of the hollow main body 110 with the hollow applicator body 130; described in more detail below). In some embodiments, the width of the hollow applicator body 130 is less than the width of the hollow main body and greater than the width of the chamber 120 (see, FIG. 1; thereby facilitating connection of the hollow main body 110 with the hollow applicator body 130; described in more detail below).

Still referring to FIG. 3, the hollow applicator body 130 is not limited to particular shape (e.g., cylindrical, rectangular, square, conical, etc.). In some embodiments, the shape of the hollow applicator body 130 (as shown in FIG. 3) is cylindrical. In some embodiments, the shape of the hollow applicator body 130 is such that it does not interfere with the securing of the hollow main body 110 with the hollow applicator body 130 (see FIG. 1) (described in more detail below).

Still referring to FIG. 3, the hollow applicator body 130 is not limited to a particular material composition (e.g., plastic, metal, Kevlar, carbon, etc.). In some embodiments, the material composition of the hollow applicator body 130 is plastic.

Still referring to FIG. 3, the applicator body mid portion 260 is a region that connects the open applicator body proximal end 250 and the open applicator body distal end 240. In some embodiments wherein the shape of the hollow applicator body 130 is cylindrical, the applicator body mid portion 260 is a cylindrical wrap-around wall. In some embodiments wherein the shape of the hollow applicator body 130 is not cylindrical (e.g., rectangular, conical, square), the applicator body mid portion 260 is one or more walls that serves to connect the open applicator body proximal end 250 and the open applicator body distal end 240.

Still referring to FIG. 3, the open applicator body distal end 240 has therein an opening of sufficient size to allow passage of a fluid (e.g., a fluid released from the chamber 120) into the interior of the hollow applicator body 130. The open applicator body proximal end 250 has therein an opening of sufficient size to allow passage of a fluid (e.g., a fluid released from the chamber 120) through the interior of the hollow applicator body 130 and into the open channel 140.

Still referring to FIG. 3, the hollow applicator body 130 has therein an elongated puncturing element 270. The puncturing element 270 has a puncturing element distal element 280, a puncturing element mid portion 290, and a puncturing element proximal end 300 engaged with the open applicator proximal end 250. The puncturing element 270 is not limited to particular size dimensions. In some embodiments, the length of the puncturing element 270 is less than the length of the hollow applicator body 130. In some embodiments, the width of the puncturing element 270 is less than the width of the hollow applicator body 130. In some embodiments, the size dimensions of the puncturing element 270 are such that fluid (e.g., fluid released from the chamber) is able to pass through the open applicator distal end 240, and through the open applicator proximal end 250.

Still referring to FIG. 3, the puncturing element 270 is not limited to a particular design. In some embodiments, the puncturing element 270 is elongated with the puncturing element distal end 280 capable of puncturing the closed chamber proximal end seal. In some embodiments, the puncturing element distal end 280 is not limited to having a particular shape (e.g., beveled, (e.g., single bevel, multi-bevel, etc.), square cut, chamfered, tapered, flared, necked, skive, swage, trocar, conical, diamond, pencil point, or truncated. In some embodiments as shown in FIG. 3A, the design of the puncturing element 270 is two-pronged with a two-pronged puncturing element distal end 280. In some embodiments as shown in FIG. 3B, the design of the puncturing element 270 is a single prong with a beveled puncturing element distal end 280. In some embodiments as shown in FIG. 3C, the design of the puncturing element 270 is a single prong with a conical puncturing element distal end 280. In some embodiments as shown in FIG. 3D, the design of the puncturing element 270 is a three-pronged with a three-pronged puncturing element distal end 280.

Still referring to FIG. 3, the puncturing element 270 is not limited to a material composition (e.g., glass, metal, plastic, ceramic, etc.). In some embodiments, the material composition of the puncturing element 270 is such that it is able puncture the closed chamber proximal end seal 220.

Still referring to FIG. 3, the open channel 140 has an open channel distal end 340 engaging the open applicator body proximal end 250, an open channel proximal end 360, and an open channel mid portion 350 positioned inbetween the open channel distal end 340 and the open channel proximal end 360. The open channel 140 is not limited to particular size dimensions. In some embodiments, the width of the open channel 140 is between 1 and 500 millimeters. In some embodiments, the length of the open channel 140 is between 1 and 500 millimeters. In some embodiments, the width of the open channel 140 is less than the width of the hollow applicator body 130. In some embodiments, the width of the open channel 140 is less than the width of the hollow main body.

Still referring to FIG. 3, the open channel 140 is not limited to particular shape (e.g., cylindrical, rectangular, square, conical, etc.). In some embodiments, the shape of the open channel 140 (as shown in FIG. 3) is cylindrical. In some embodiments, the shape of the open channel 140 is such that it does not interfere with fluid flowing from the hollow applicator body 130 into the open chamber distal end 340, through the interior of the open chamber 140, and through the open chamber proximal end 360.

Still referring to FIG. 3, the open channel 140 is not limited to a particular material composition (e.g., plastic, metal, Kevlar, carbon, etc.). In some embodiments, the material composition of the open channel 140 is plastic.

Still referring to FIG. 3, the open chamber mid portion 350 is a region that connects the open chamber distal end 340 and the open chamber proximal end 360. In some embodiments wherein the shape of the open chamber 140 is cylindrical, the open chamber mid portion 350 is a cylindrical wrap-around wall. In some embodiments wherein the shape of the open chamber 140 is not cylindrical (e.g., rectangular, conical, square), the open chamber mid portion 350 is one or more walls that serves to connect the open chamber distal end 340 and the open chamber proximal end 360.

Still referring to FIG. 3, the open chamber distal end 340 has therein an opening of sufficient size to allow passage of a fluid (e.g., a fluid released from the chamber) from the interior of the hollow applicator body 130 and into the interior of the open chamber 140. Similarly, the open chamber proximal end 360 has therein an opening of sufficient size to allow passage of a fluid (e.g., a fluid released from the chamber) from the interior of the open chamber 140 and through the open chamber proximal end 360.

Referring to FIGS. 1, 2 and 3, the hollow main body 110 is configured to engage and connect with the hollow applicator body 130. In some embodiments, the hollow main body 110 is configured to engage and connect with the hollow applicator body 130 such that fluid released from the chamber 120 is able to flow through the open main body proximal end 170 and into the interior of the hollow applicator body 130.

Still referring to FIGS. 1, 2, and 3, the hollow main body 110 is not limited to a particular manner of engaging and connecting with the hollow applicator body 130. In some embodiments, the hollow main body 110 is configured to slide within the interior of the hollow applicator body 130 resulting in a securing of the hollow main body 110 with the hollow applicator body 130. In some embodiments, the hollow applicator body 130 is configured to slide within the interior of the hollow main body 110 resulting in a securing of the hollow main body 110 with the hollow applicator body 130. In some embodiments, the hollow applicator body 130 is configured to lock within the interior of the hollow main body 110 resulting in a securing of the hollow main body 110 with the hollow applicator body 130.

In some embodiments, the hollow applicator body is configured to lock within the interior of the hollow main body in a “stand-by” position or an “activation” position. In some embodiments, the stand-by position represents a locking of the hollow main body with the hollow applicator body wherein the closed main body proximal end is not in contact with the puncturing element. In some embodiments, the activation position represents a positioning of the hollow main body with the hollow applicator body wherein the closed main body proximal end is in contact with the puncturing element (such that the closed main body proximal end seal is punctured by the puncturing element thereby releasing the fluid within the chamber).

The apparatuses are not limited to particular configurations permitting such “stand-by” positions and/or an “activation” positions. In some embodiments as shown in FIG. 3, the hollow applicator body 130 has thereon applicator body tabs 310 positioned near the open applicator body distal end 240. In some embodiments as shown in FIG. 2, the hollow main body 110 has thereon stand-by slots 320 positioned near the open main body proximal end 170, and activation slots 330 positioned along the main body mid portion 190.

In some embodiments, such applicator body tabs, stand-by slots, and activation slots are positioned such that upon securing of the hollow main body with the hollow applicator body, the applicator body tabs are either positioned within the stand-by slots or the activation slots (see, FIG. 1). In some embodiments, upon positioning of the applicator body tabs within the stand-by slots, application of a distal force to the hollow main body will dislodge the applicator body tabs from the respective stand-by slots and into the activation slots, thereby resulting in contact between the closed chamber proximal end and the puncturing element which results in puncturing of the closed chamber proximal end seal and release of its contents (e.g., fluid).

Referring to FIG. 3, the applicator body tabs 310 are not limited to particular size dimensions. In some embodiments the size of the applicator body tabs 310 are such that the applicator body tabs 310 do not hinder securing of the hollow main body 110 with the hollow applicator body 130.

Referring to FIG. 2, the stand-by slots 320 are not limited to particular size dimensions. In some embodiments, the length and width dimensions of the stand-by slots 320 are slightly larger than the length and width dimensions of the applicator body tabs for purposes of locking such applicator body tabs within the stand-by slots 320. In some embodiments, the size of the stand-by slots 320 are such that applicator body tabs can be locked therewithin and, absent application of a distal force to the hollow main body, will remain secured within such stand-by slots 320. The activation slots 330 are not limited to particular size dimensions. In some embodiments, the width of the activation slots 330 is slightly larger than the width of the applicator body tabs for purposes of preventing undesired lateral movement of the applicator body tabs. In some embodiments, the length of the activation tabs 330 runs along at least a portion of the the main body mid portion 190 (e.g., 10%, 20%, 40%, 50%, 70%, 80%, 90%, 95%, 99%, 99.9% of the length of the main body mid portion 190). In some embodiments, the length of the activation tabs 330 runs through the main body mid portion 190 and up to the closed main body distal end 180. In some embodiments, the length of the activation slots 330 is such that upon application of a distal force upon the hollow main body 110, the hollow main body 110 will move in a proximal direction thereby resulting in contact between the closed chamber proximal end 210 and the puncturing element which results in puncturing of the closed main body proximal end seal 220 and release of its contents (e.g., fluid).

In some embodiments, the open channel is configured to be releasably secured with an enclosed swab housing. The open channel is not limited to releasably securing with a particular type of swab housing. In some embodiments, the swab housing is any type of enclosure that is configured to contain an elongated swab. In some embodiments, the swab housing is any type of enclosure that is configured to sterilely contain an elongated swab. In some embodiments, the swab housing is a SecurSwab (Bode Technology) type of swab housing. In some embodiments, the swab housing is similar to a SecurSwab (Bode Technology) type of swab housing.

The open channel is not limited to a particular manner of releasably securing with a swab housing. In some embodiments, the open channel proximal end connects with an opening within a swab housing. In some embodiments, the open channel proximal end locks with an opening within a swab housing. In some embodiments, the open channel proximal end slides within an opening within a swab housing. In some embodiments, the open channel proximal end connects with an opening within a swab housing such that fluid released within the apparatus is able to flow through the apparatus and into the swab housing. In some embodiments, the open channel proximal end connects with an opening within a swab housing such that fluid released within the apparatus is able to flow through the apparatus, into the swab housing, and onto a swab contained within the swab housing, while maintaining sterility. In some embodiments, the open channel proximal end connects with an opening within a swab housing such that fluid released within the apparatus is able to flow through the apparatus, into the swab housing, and onto the cotton portion of a swab contained within the swab housing, while maintaining sterility.

In alternate embodiments, the chamber is a fractionable ampoule. In such embodiments, upon securing of the hollow main body with the hollow applicator body in a stand-by position, application of a distal force to the hollow main body results in contact between the fractionable ampoule and the puncturing element which results in a “breaking” of the fractionable ampoule thereby releasing its contents (e.g., fluid).

In alternate embodiments, the chamber does not contain a fluid. In such embodiments, upon securing of the hollow main body with the hollow applicator body in a stand-by position, application of a distal force to the hollow main body results in contact between the chamber and the puncturing element which results in a vacuum based evacuation force from the swab housing, through the interior of the apparatus and into the chamber. In some embodiments, particles on a swab may thereby be forced off of the swab and into the chamber for testing purposes.

In some embodiments, the fluid is applied into the swab housing in a “squirting manner.” As such, in some embodiments, successive applications of a “distal force” to the apparatus results in successive “squirting” of fluid into the swab housing.

In certain embodiments, systems are provided which include such apparatuses. For example, in some embodiments, systems having an apparatus and a swab contained within a swab housing (e.g., a SecurSwab swab (Bode Technology) housing or any type or kind of variation of a SecurSwab (Bode Technology) swab housing) are provided. In some embodiments, the apparatus is secured with the swab housing such that application of a distal force to the main body applicator will result in a release of fluid through the interior of the apparatus and onto the swab (e.g., the cotton portion of the swab).

In certain embodiments, kits are provided which include such apparatuses. For example, in some embodiments, kits having an apparatus, a swab, and a swab housing (e.g., a SecurSwab (Bode Technology) swab housing or any type or kind of variation of a SecurSwab (Bode Technology) swab housing) are provided.

The apparatus, systems, and kits described herein find use in any type of setting requiring the sterile application with a swab (e.g., a forensic setting, a food safety setting, a medical sampling setting, an environmental setting, a cosmetic setting, and/or an industrial cleaning setting) (e.g., any setting requiring the sterile use of swab having thereon any desired type of fluid).

In some embodiments wherein the setting is a DNA forensic setting, the provided apparatuses, systems, and/or kits are used to sterilely apply a desired fluid (e.g., sterile water) (e.g., DNA buffer (e.g., 10 mM tris-HCl)) to a swab contained within a swab housing (e.g., a SecurSwab (Bode Technology) swab housing or any type or kind of variation of a SecurSwab (Bode Technology) swab housing) for a sterile use within the forensic setting (e.g., sterilely collecting forensic evidence (e.g., DNA)). In some embodiments wherein the setting is an environmental setting, the provided apparatuses, systems, and/or kits are used to sterilely apply a desired fluid (e.g., organic solvent) to a swab contained within a swab housing (e.g., a SecurSwab (Bode Technology) swab housing or any type or kind of variation of a SecurSwab (Bode Technology) swab housing) for use within the environmental setting. In some embodiments wherein the setting is health related setting, the provided apparatuses, systems, and/or kits are used to sterilely apply a desired fluid (e.g., antibacterial and/or antimicrobial) to a swab contained within a swab housing (e.g., a SecurSwab (Bode Technology) swab housing or any type or kind of variation of a SecurSwab (Bode Technology) swab housing) for use within the health setting (e.g., sterilely cleansing a treatment area) (e.g., sterilely cleansing the skin or treatment area of a patient). In some embodiments wherein the setting is food safety related setting, the provided apparatuses, systems, and/or kits are used to sterilely apply a desired fluid (e.g., liquid culture based media) to a swab contained within a swab housing (e.g., a SecurSwab (Bode Technology) swab housing or any type or kind of variation of a SecurSwab (Bode Technology) swab housing) for use within the food safety related setting (e.g., to collect and promote the viability or incubation of an organism). In some embodiments, samples can be collected either manually or automatically.

There is no required manner for utilizing the provided apparatuses, systems, and kits. In some embodiments, the step-by-step technique presented in FIG. 4 is utilized. As shown in FIG. 4 Step 1, an apparatus is secured with a swab housing (e.g., a SecurSwab (Bode Technology) swab housing or any type or kind of variation of a SecurSwab (Bode Technology) swab housing) containing a swab. Next, as shown in FIG. 4 Step 2, a distal force is applied to the main body thereby resulting in a puncturing of the chamber within the apparatus and the release of the fluid contained within the chamber. Next, as shown in FIG. 4 Step 3, the fluid is permitting to flow through the apparatus and onto the cotton portion of a swab contained within the swab housing. Next, as shown in FIG. 4 Steps 4 and 5, the swab housing is removed rendering the swab ready for use (e.g., to collect a sample) (e.g., to apply the fluid on the cotton portion of the swab). Next, as shown in FIG. 6, the swab can be returned to the swab housing and, if desired, the apparatus can be removed.

In some embodiments, the apparatuses, systems, kits and methods may be used to sterilely apply a fluid to a swab prior to or after collection of a sample with the swab. For example, in some embodiments, the apparatuses, systems, kits and methods may be used to sterilely apply a fluid to a swab prior to collection of a sample with the swab. For example, in some embodiments, the apparatuses, systems, kits and methods may be used to sterilely apply a fluid to a sample already collected with a swab (e.g., a swab may be used to collect a blood sample which could be stored within a swab housing for an extended period of time until sterile application of a fluid to the sample within the swab housing is desired (e.g., for rehydration purposes)).

As described above, the provided apparatuses, systems, kits, and methods represent significant improvements involving the sterile use of swabs requiring the sterile application of a fluid onto the swab prior to its use. For example, unlike currently available products (e.g., a SecurSwab (Bode Technology) swab housing), the provided apparatuses, systems, kits, and methods permit a user to sterilely apply a desired fluid to a swab contained within a swab housing without having to remove the swab thereby compromising its sterility.

In certain embodiments, apparatuses are provided for connecting with a swab housing (containing a swab) wherein, following such connection, a simple downward “pushing” or “popping” of the apparatus onto the swab housing results in a sterile release a fluid through the apparatus, into the swab housing, and onto the swab. In some embodiments, the apparatuses may be connected with a swab housing that has therein a sample without an accompanying swab (e.g., a swab that had a sample thereon that was exposed to a swab housing but removed thereby leaving portions of the sample within the housing). In such embodiments, the simple downward “pushing” or “popping” of the apparatus onto the swab housing results in a sterile release a fluid through the apparatus, into the swab housing, and onto the sample within the housing.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the medical sciences are intended to be within the scope of the following claims.

We claim:

1. An apparatus, comprising
a hollow main body having an open main body proximal end, a closed main body distal end, and a main body mid portion positioned inbetween the closed main body proximal end and the open main body distal end;
a chamber positioned within the interior of the hollow main body, the chamber having a closed chamber distal end engaging the closed main body distal end, a closed chamber proximal end, wherein the closed chamber proximal end is puncturable, and a chamber mid portion positioned inbetween the closed chamber distal end and the closed chamber proximal end;
a hollow applicator body having an open applicator body distal end, an open applicator body proximal end, an applicator body mid portion positioned inbetween the open applicator body distal end and the open applicator body proximal end, and an elongated puncturing element positioned within the interior of the applicator body, the puncturing element having a puncturing element distal end, a puncturing element proximal end, and a puncturing element mid portion positioned between the puncturing element distal end and the puncturing element proximal end; and
an open channel having an open channel distal end engaging the open applicator body proximal end, an open channel proximal end, and an open channel mid portion positioned inbetween the open channel distal end and the open channel proximal end;
wherein the main body is releasably secured with the applicator body such that the chamber proximal end is not in contact with the puncturing element distal end;
wherein the main body is configured such that application of a distal force to the main body results in distal movement of the main body in relation to the applicator body, wherein such distal movement of the main body results in engagement and puncturing of the closed chamber proximal end through engagement of the closed chamber proximal end and the puncturing element distal end.

2. The apparatus of claim 1, wherein the chamber contains a fluid.

3. The apparatus of claim 2, wherein the apparatus is configured such that a puncturing of the closed chamber proximal end results in release of the fluid from the chamber.

4. The apparatus of claim 1, wherein the chamber is empty.

5. The apparatus of claim 1, wherein the closed chamber proximal end is flush or recessed relative to the main body proximal end.

6. The apparatus of claim 1, wherein main body has a cylindrical shape.

7. The apparatus of claim 1, wherein the hollow applicator body has a cylindrical shape.

8. The apparatus of claim 1, wherein the open channel has a cylindrical shape.

9. The apparatus of claim 1, wherein main body has a rectangular shape.

10. The apparatus of claim 1, wherein the hollow applicator body has a rectangular shape.

11. The apparatus of claim 1, wherein the open channel has a rectangular shape.

12. The apparatus of claim 1, wherein the swab housing has a rectangular shape.

13. A system, comprising an apparatus of claim 1, an elongated swab, and a swab housing;
the elongated swab having a swab proximal end and a swab distal end, wherein a cotton portion is positioned at the swab proximal end;
the swab housing having a closed swab housing proximal end and an open swab housing distal end;
wherein the swab is positioned within the swab housing such the cotton portion of the swab is flush or recessed relative to the open swab housing distal end;
wherein the open channel proximal end is releasably secured with the open housing distal end such that a fluid tight seal is generated between interior of the apparatus and the interior of the swab housing;
wherein the main body is releasably secured with the applicator body such that the chamber proximal end is not in contact with the puncturing element distal end;
wherein the main body is configured such that application of a distal force to the main body results in distal movement of the main body in relation to the applicator body, wherein such distal movement of the main body results in engagement and puncturing of the closed chamber proximal end through engagement of the closed chamber proximal end and the puncturing element distal end.

14. A method for applying a fluid to an elongated swab, comprising
a) providing
an elongated swab positioned within a swab housing, the swab having a swab proximal end and a swab distal end; wherein a cotton portion is positioned at the swab proximal end; the swab housing having a closed swab housing proximal end and an open swab housing distal end; wherein the swab is positioned within the swab housing such the cotton portion of the swab is flush or recessed relative to the open swab housing distal end; and
an apparatus of claim 1;
b) securing the apparatus with the swab housing through securing the open channel proximal end with the open swab housing distal end;
c) applying a distal force to the main body such that the main body moves in a distal manner in relation to the applicator body, wherein such distal movement of the main body results in engagement and puncturing of the closed chamber proximal end through engagement of the closed chamber proximal end and the puncturing element distal end, wherein the puncturing of the closed chamber proximal end results in a release of the fluid within the chamber through the interior of the main body, through the interior of the applicator body, through the interior of the open channel, through the open swab housing distal end and onto the cotton portion of the swab.

15. The method of claim 14, further comprising the step of
d) removing the apparatus from the swab housing.

16. The method of claim 15, further comprising the step of
e) removing the swab from the swab housing.

17. The method of claim 16, further comprising the step of
f) collecting a sample with the swab.

18. The method of claim 17, wherein the sample is one or more of a forensic sample and a biological sample.

19. An apparatus for sterilely delivering fluid to a swab contained within a housing, comprising an enclosed chamber containing a fluid, a puncturing element, and an exit channel extending through the apparatus,
wherein the exit channel is configured for attachment with a housing containing a swab,
wherein the apparatus is further configured such that upon attachment with a swab housing, the chamber can be punctured by the puncturing element thereby releasing the fluid from the chamber,
wherein releasing of the fluid from the chamber results in flow of the fluid through the exit port and into the housing and onto the swab.
